(19) United States
(12) Patent Application Publication
(10) Pub. No.: US 2026/0235716 A1
(43) Pub. Date: Aug. 13, 2026

(54) SITE-SPECIFIC OPTIMIZATION OF RADIO PROCESSING VIA DIGITAL TWIN SIMULATION AND FIELD SENSOR-BASED DATA

(71) Applicant: VIAVI Solutions Inc, Chandler, AZ (US)

(72) Inventors: Paul HARRIS, Havant (GB); Ian C. WONG, Austin, TX (US); James Gordon BEATTIE, JR., Live Oak, FL (US); Ilya SAMOKHIN, Paphos (CY)

(21) Appl. No.: 19/049,637

(22) Filed: Feb. 10, 2025

(51) Int. Cl. G01S 5/02; H04W 16/18; H04W 16/22

(52) U.S. Cl. CPC G01S 5/02521; H04W 16/18; H04W 16/22

(57) ABSTRACT

A system for an open radio access network (RAN) includes an open radio unit (O-RU) configured to transmit and receive radio frequency signals via a plurality of antennas according to one or more site-specific channel information (SSCI) parameters that correspond to a radio environment associated with a coverage area of the O-RU; a ray-tracing engine configured to receive field sensor data generated by one or more sensors deployed in the coverage area, the field sensor data corresponding to the radio environment, and generate the one or more SSCI parameters based on the field sensor data; and a controller configured to receive the field sensor data and provide the field sensor data to the ray-tracing engine, and receive the one or more SSCI parameters from the ray-tracing engine and provide the one or more SSCI parameters to the O-RU for configuring the O-RU with the one or more SSCI parameters.

### BACKGROUND

A wireless communication system may use radio waves to transmit wireless communication signals between a transmitter (e.g., a device that transmits the wireless communication signal) and a receiver (e.g., a device that receives the wireless communication signal). In some cases, a propagation model (e.g., a set of equations and algorithms) may be used to estimate characteristics of a wireless communication signal based on parameters such as, for example, frequency, antenna height, properties of an environment through which the wireless communication signal is transmitted, and/or properties of one or more objects (e.g., buildings, vehicles, and/or the like) located within the environment.

### SUMMARY

In some implementations, a system for an open radio access network (RAN) includes an open radio unit (O-RU) configured to transmit and receive radio frequency (RF) signals via a plurality of antennas according to one or more site-specific channel information (SSCI) parameters that correspond to a radio environment associated with a coverage area of the O-RU; a ray-tracing engine configured to receive field sensor data generated by one or more sensors deployed in the coverage area, the field sensor data corresponding to the radio environment, and generate the one or more SSCI parameters based on the field sensor data; and a controller communicatively coupled to the ray-tracing engine and the O-RU, wherein the controller is configured to receive the field sensor data and provide the field sensor data to the ray-tracing engine, and wherein the controller is further configured to receive the one or more SSCI parameters from the ray-tracing engine and provide the one or more SSCI parameters to the O-RU.

In some implementations, a field-based handheld tool (FBHT) for a RAN includes a communication interface for being connected to a cloud-based controller of the RAN; one or more memories; and one or more processors, communicatively coupled to the one or more memories, configured to: connect to a ray-tracing engine via the cloud-based controller to trigger the ray-tracing engine to generate SSCI parameters that correspond to a radio environment associated with a coverage area of a radio unit (RU) and to load the SSCI parameters into the RU.

In some implementations, a method of configuring an RU of a RAN includes triggering, by an FBHT, a ray-tracing engine to generate SSCI parameters that correspond to a radio environment associated with a coverage area of an RU; receiving, by the ray-tracing engine, field sensor data generated by one or more sensors deployed in the coverage area, the field sensor data corresponding to the radio environment; generating, by the ray-tracing engine, the SSCI parameters based on the field sensor data; receiving, by the RU, the SSCI parameters; and adapting, by the RU, one or more antenna parameters associated with the RU based on the one or more SSCI parameters.

### BRIEF DESCRIPTION OF THE DRAWINGS

FIG. 1 is a diagram of an example environment in which systems and/or methods described herein may be implemented.

FIG. 2 is a diagram of an example RAN in which systems and/or methods described herein may be implemented.

FIG. 3 shows a system for a RAN according to one or more implementations.

FIG. 4 is a diagram of example components of a device associated with site-specific optimization of radio processing via digital twin simulation and field sensor-based data.

FIG. 5 is a flowchart of an example process associated with site-specific optimization of radio processing via a digital twin simulation and field sensor-based data.

### DETAILED DESCRIPTION

The following detailed description of example implementations refers to the accompanying drawings. The same reference numbers in different drawings may identify the same or similar elements.

Existing cell sites are typically limited in or have no ability to optimize operating parameters for a deployed location, where the operating parameters are configured for a specific radio environment of the deployed location. Thus, transmission and reception of radio-frequency signals from a cell site may not be optimized for the specific radio environment, which may lead to lower throughput, poor signal connection, and/or loss in signal connection related to the radio-frequency signals.

Currently, frequency range 3 (FR3) bands, such as 8 GHz and 15 GHz bands, are being considered for wireless communications. For example, FR3 bands may be used to enhance or enable 5G and 6G networks, as well as future generation networks. FR3 bands may require many more massive multiple-input, multiple-output (MIMO) antenna elements to be added to existing cell sites to achieve comparable coverage in these higher frequencies. An open radio access network (O-RAN) open fronthaul 7.2x interface may enable a scale up in antennas but may sacrifice massive MIMO performance, which may hamper the ability of open radio units (O-RUs) to remain competitive in the wider market. Uplink performance improvement (ULPI) may address this issue by moving some of the open distributed unit (O-DU) processing to the O-RU. However, moving some of the O-DU processing to the O-RU increases the complexity of the O-RU, which, in turn, increases cost and energy consumption of the O-RU. This complexity ultimately stems from the channel estimation and equalization functions performed by the O-RU. These functions scale cubically (n³) to the number of antenna elements (n), primarily because the algorithms underlying these functions were devised to consider the most generic deployment scenarios and propagation environments.

Some implementations described herein provides a system that may lower the complexity, cost, and energy consumption of O-RUs, and may improve the performance of the O-RUs. In some implementations, the O-RUs may be massive MIMO O-RUs. For example, an O-RU may receive one or more site-specific channel information (SSCI) parameters that correspond to a radio environment associated with a coverage area of the O-RU, and may generate channel state information (CSI) and/or one or more antenna operating parameters based on the one or more SSCI parameters. Thus, the O-RU and/or the antennas may be optimized according to SSCI parameters, which are specific to the radio environment associated with a coverage area of the O-RU.

In some implementations, a field-based handheld tool (FBHT) may be configured to connect to a ray-tracing engine (RTE) via a cloud-based controller (CBC) to trigger the generation of the SSCI parameters and subsequently load these parameters into the O-RU via an appropriate communication interface. In some implementations, the FBHT may transmit test waveforms via the O-RU that can be measured by one or more sensors deployed in the network (e.g., in the radio environment) and fed back to the RTE as sensor-based data via the CBC to further refine a site-specific ray tracing model, from which the SSCI parameters are based.

The system may use SSCI modelling and field sensor-based data to tune the O-RU. For example, the O-RU may use the SSCI parameters to tune channel estimation, beamforming, and/or equalization algorithms for a specific site at which the O-RU is operating, and enable the channel estimation, beamforming, and/or equalization algorithms to consider up-to-date deployment scenarios and propagation environments. Thus, the system may lower complexity, cost, and energy consumption and improve the performance of a massive MIMO O-RU.

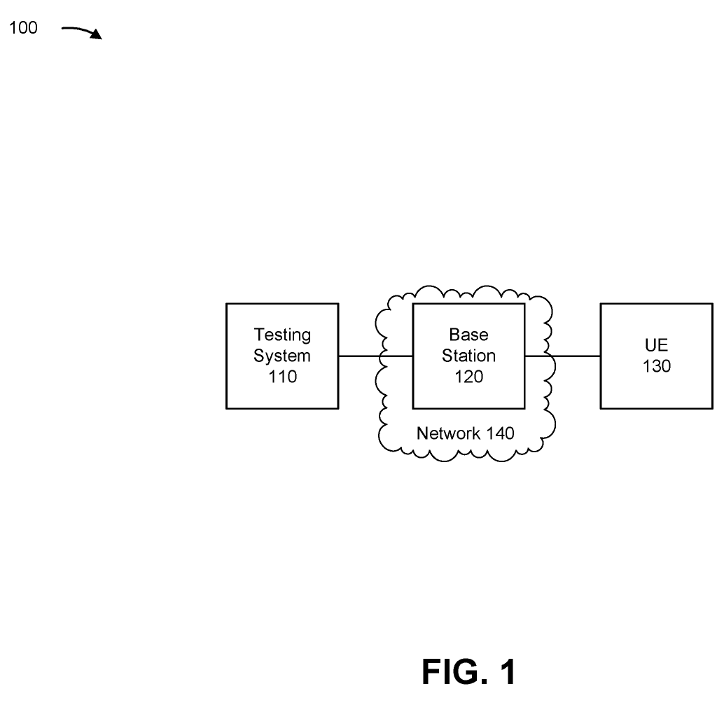

FIG. 1 is a diagram of an example environment 100 in which systems and/or methods described herein may be implemented. As shown in FIG. 1, environment 100 may include a testing system 110, a base station 120, a user equipment (UE) 130, and a network 140. Devices of environment 100 may interconnect via wired connections, wireless connections, or a combination of wired and wireless connections.

Testing system 110 includes one or more devices capable of communicating with base station 120 and/or a network (e.g., network 140), such as to perform processing of a signal produced by base station 120. Testing system 110 may communicate with base station 120 by a wired connection, as described elsewhere herein. In some implementations, testing system 110 may wirelessly communicate with base station 120.

Testing system 110 may include a beamforming network, a feedback component, and/or a test component as described elsewhere herein. The beamforming network may include an analog beamforming network that outputs a signal associated with a beam direction, as described elsewhere herein. The feedback component may include a passive RF component, such as an RF coupler, that outputs a feedback signal based on an output signal of the beamforming network or a calibration signal of a calibration component of the base station 120, as described elsewhere herein. The test component may include one or more devices capable of receiving, generating, storing, processing, and/or providing information associated with a signal, such as an RF signal (e.g., an output signal of the beamforming network). For example, the test component may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

Base station 120 includes one or more devices capable of communicating with a UE using a cellular radio access technology (RAT). For example, base station 120 may include a base transceiver station, a radio base station, a node B, an evolved node B (eNB), a gNB, a base station subsystem, a cellular site, a cellular tower (e.g., a cell phone tower or a mobile phone tower), an access point, a transmit receive point (TRP), a radio access node, a macrocell base station, a microcell base station, a picocell base station, a femtocell base station, or a similar type of device. Base station 120 may transfer traffic between a UE (e.g., using a cellular RAT), other base stations 120 (e.g., using a wireless interface or a backhaul interface, such as a wired backhaul interface), and/or network 140. Base station 120 may provide one or more cells that cover geographic areas. Some base stations 120 may be mobile base stations. Some base stations 120 may be capable of communicating using multiple RATs.

In some implementations, base station 120 may perform scheduling and/or resource management for UEs covered by base station 120 (e.g., UEs covered by a cell provided by base station 120). In some implementations, base stations 120 may be controlled or coordinated by a network controller, which may perform load balancing and/or network-level configuration. The network controller may communicate with base stations 120 via a wireless or wireline backhaul. In some implementations, base station 120 may include a network controller, a self-organizing network (SON) module or component, or a similar module or component. In other words, a base station 120 may perform network control, scheduling, and/or network management functions (e.g., for other base stations 120 and/or for uplink, downlink, and/or sidelink communications of UEs covered by the base station 120). In some implementations, base station 120 may include a central unit and multiple distributed units. The central unit may coordinate access control and communication with regard to the multiple distributed units. The multiple distributed units may provide UEs and/or other base stations 120 with access to network 140.

In some implementations, base station 120 may be capable of multiple-input, multiple-output (MIMO) communication (e.g., beamformed communication). In some implementations, base station 120 may include a calibration component for phase calibration of signals produced or received by base station 120, as described elsewhere herein. In a testing scenario, one or more antenna elements (e.g., an antenna array) of base station 120 may be disconnected, and base station 120 may be connected to a test panel, as described elsewhere herein.

In a traditional cellular network, the base station 120 may include a radio unit (RU) and a baseband unit (BBU). The RU may handle radio frequency (RF) signal transmission and reception (e.g., RF processing) to and from the UE 130. The RU may be located proximate to, and is coupled to, the one or more antennas. Thus, the RU may receive RF signals from the UE 130 via the one or more antennas, and may transmit RF signals to the UE 130 via the one or more antennas. The RU may convert baseband signals received from the BBU to RF for antenna transmission, and may convert RF signals received from the one or more antennas to baseband for the BBU. In some cases, the RU may be referred to as a remote radio unit (RRU) or a remote radio head (RRH). The BBU may perform baseband processing, including modulation, encoding, and signal processing tasks. Thus, the BBU may process digital radio signals. The BBU may communicate with the RU using a common public radio interface (CPRI). The BBU may take the signal information (e.g., data) received from the RU, and process the signal information to be forwarded to a core network (e.g., including a network controller). Additionally, the BBU may receive signal information from the core network, and process the signal information to be sent to the RU. The BBU may be connected to the core network via one of more fiber optic cables. The core network may perform management functions, including user authentication, mobility management, session and connection management, data routing, and/or policy control, among other examples.

In an open RAN, the base station 120 may be disaggregated into different components with open interfaces. For example, the base station 120 may be disaggregated into an open RU (O-RU), an open distributed unit (O-DU), and an open centralized unit (O-CU). In other words, the BBU may be formed by the O-DU and the O-CU. The O-RU may perform RF-related tasks such as transmitting and receiving signals (e.g., RF processing), beamforming, RF amplification, and antenna control.

The O-DU may handle lower-layer baseband processing, such as the physical (PHY) layer, including error correction and signal modulation/demodulation. The O-DU may implement scheduling, error correction, and/or resource allocation. In some implementations, such as in centralized deployments, the O-DU may manage user traffic and support multiple O-RUs. The O-CU may perform higher-layer processing, such as radio resource management, and may handle network-layer protocols.

The O-DU may operate radio link control and medium access control (MAC) layers in addition to some of the physical layers. Thus, the O-DU may be controlled by the O-CU. The O-CU may operate a radio resource control protocol, which may conduct many functions, including information broadcasting, establishing and releasing connections between the user equipment and the RAN, and controlling a quality of service. The O-CU may also operate with a packet data convergence protocol, which may compress and decompress internet protocol (IP) data stream headers and may transfer user data, among other technical functions.

The O-DU may be connected to the O-RU via a fronthaul communication link (e.g., CPRI or enhanced CPRI (eCPRI)), the O-DU may be connected to the O-CU via a midhaul communication link, and the O-CU may be connected to the core network via a backhaul communication link. In some implementations, the fronthaul communication link, the midhaul communication link, and/or the backhaul communication link may be optical fiber connections.

UE 130 may include one or more devices capable of communicating with base station 120 and/or a network (e.g., network 140). For example, UE 130 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. UE 130 may be capable of communicating using uplink (e.g., UE to base station) communications, downlink (e.g., base station to UE) communications, and/or sidelink (e.g., UE-to-UE) communications. In some implementations, UE 130 may include a machine-type communication (MTC) UE, such as an evolved or enhanced MTC (eMTC) UE. In some implementations, UE 130 may include an Internet of Things (IoT) UE, such as a narrowband IoT (NB-IoT) UE.

Network 140 includes one or more wired and/or wireless networks. For example, network 140 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks. In some implementations, the network 140 may be a radio area network (RAN). For example, the network 140 may be an open RAN.

The quantity and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

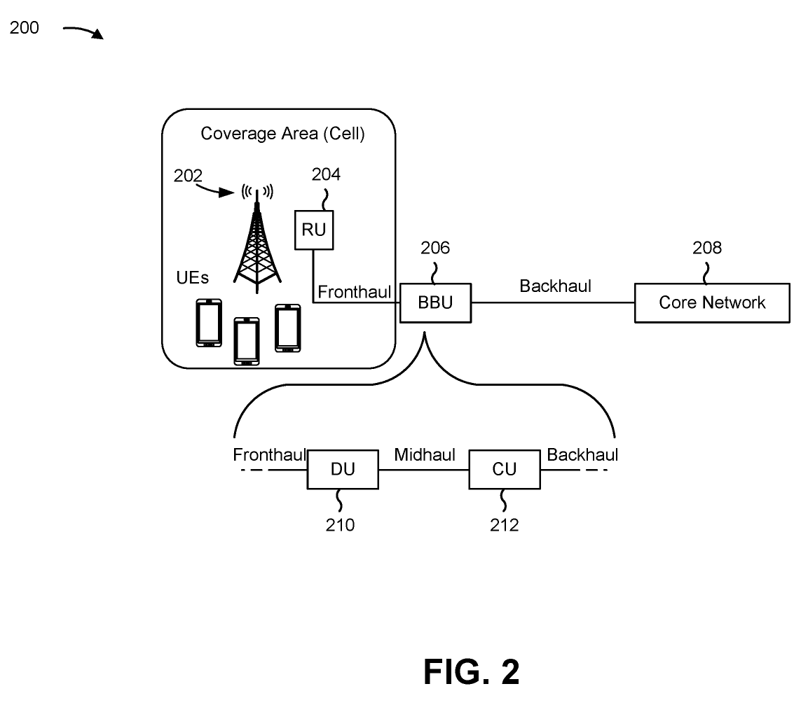

FIG. 2 is a diagram of an example RAN 200 in which systems and/or methods described herein may be implemented. In some implementations, the RAN 200 may be an open RAN (e.g., an O-RAN) and/or a 5G RAN. In some implementations, the RAN 200 may be another type of RAN, including a future generation RAN, such as 6G RAN. The RAN 200 may include an antenna tower 202 (e.g., a cell tower) including one or more antennas. For example, the antenna tower 202 may include one or more antenna arrays, such as one or more massive MIMO arrays. The antenna tower 202 may be configured to transmit and receive signals within a coverage area, sometimes referred to as a cell. Thus, the antenna tower 202 may interact with one or more UEs located within the coverage area. Additionally, the RAN 200 may include an RU 204 (e.g., an O-RU), a BBU 206, and a core network 208. The BBU 206 may include a DU 210 (e.g., an O-DU) and a CU 212 (e.g., an O-CU). The RU 204 may interface with or otherwise communicate with the one or more UEs via the antenna tower 202 (e.g., via the one or more antennas). Thus, the RAN 200 may connect one or more UEs the core network 208.

The RU 204 may perform beamforming and antenna control. For example, the RU 204 may control one or more antenna parameters to support advanced antenna techniques, such as massive MIMO and beamforming for improved signal quality and efficiency. In addition, the RU 204 may perform synchronization. For example, the RU 204 may maintain precise timing for signal transmission and reception, which may be beneficial for the operation of cellular networks.

The RU 204 and the DU 210 may be connected by a fronthaul communication link (e.g., CPRI or eCPRI), for example, for exchanging fronthaul packets (e.g., open fronthaul packets). Uplink data may flow from the RU 204 to the DU 210, and ultimately to the core network 208. Conversely, downlink data may flow from the DU 210 to the RU 204, and ultimately to a UE. In open fronthaul communication, uplink data may be encapsulated as IQ (in-phase and quadrature) data and transmitted over protocols, such as eCPRI, to the DU 210 for further baseband processing.

In addition, the DU 210 and the CU 212 may be connected by a midhaul communication link. The CU 212 may be connected to the core network 208 via a backhaul communication link.

As indicated above, FIG. 2 is provided as an example. Other examples may differ from what is described with regard to FIG. 2. The number and arrangement of devices and components shown in FIG. 2 are provided as an example. In practice, there may be additional devices or components, fewer devices or components, different devices or components, or differently arranged devices or components than those shown in FIG. 2.

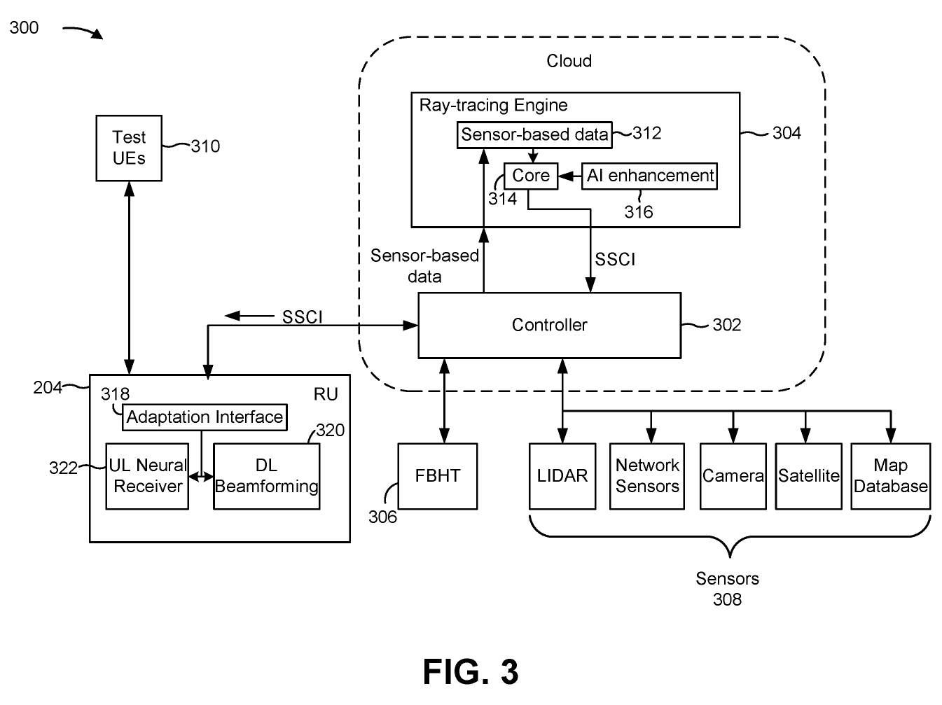

FIG. 3 shows a system 300 for a RAN according to one or more implementations. The RAN may be similar to the RAN 200 described in connection with FIG. 2 (e.g., an O-RAN and/or a 5G RAN). The system 300 includes an RU 204 (e.g., an O-RU), as similarly described above. In addition, the system 300 may include a controller 302, a ray-tracing engine 304, a field-based handheld tool (FBHT) 306, one or more sensors 308 (e.g., sensor data sources), and one or more test UEs 310.

The controller 302 may be communicatively coupled to the RU 204, the ray-tracing engine 304, the FBHT 306, and/or the sensors 308. In some implementations, the controller 302 may be a cloud-based controller.

The RU 204 may transmit and receive RF signals via a plurality of antennas according to one or more site-specific channel information (SSCI) parameters that correspond to a radio environment associated with a coverage area of the RU 204 (e.g., a coverage area of the plurality of antennas or the cell). The plurality of antennas may be arranged on an antenna tower, such as antenna tower 202, as described in connection with FIG. 2.

The sensors 308 may generate field sensor data (e.g., sensor-based data) corresponding to the radio environment. For example, the sensors 308 may include one or more light detection and ranging (LIDAR) sensors, network sensors, cameras, satellites, or databases (e.g., map databases). In some implementations, one or more sensors 308 may be deployed in the coverage area. In some implementations, one or more sensors 308 may measure one or more test waveforms and generate field sensor data based on the measured test waveforms. The one or more test UEs 310 may also behave as sensors. For example, the one or more test UEs 310 may measure one or more test waveforms and generate field sensor data (e.g., sensor-based data) based on the measured test waveforms. Thus, the field sensor data may include signal strength information, LIDAR information, image information, and/or map information pertinent to the radio environment of the coverage area that is specific to the RU 204 (e.g., to the plurality of antennas).

The controller 302 may receive the field sensor data form the sensors 308 and/or the test UEs 310, and provide the field sensor data to the ray-tracing engine 304. In the case of the test UEs 310, the controller 302 may receive the field sensor data, generated by the test UEs 310, through the RU 204. In the case of the sensors 308, the controller 302 may receive the field sensor data, generated by the sensors 308, either directly or indirectly from the sensors 308 via one or more communication links or communication buses.

Ray tracing is a propagation modeling approach for estimating characteristics of a ray considering any reflection, refraction, scattering, and/or diffraction of the ray that may be caused by objects within an environment via which the ray is transmitted. The ray-tracing engine 304 may receive the field sensor data generated from the controller 302. In some implementations, the ray-tracing engine 304 may be a cloud-based ray-tracing engine that is coupled to the controller 302 via a cloud network. The ray-tracing engine 304 may generate the one or more SSCI parameters based on the field sensor data. As a result, the SSCI parameters are specific to the radio environment measured by the sensors and/or the test UEs 310. The controller 302 may receive the SSCI parameters from the ray-tracing engine 304 and provide the SSCI parameters to the RU 204.

The ray-tracing engine 304 may include a memory 312, a processing core 314, and an artificial intelligence (AI) model 316, such as a machine learning model. The memory 312 may receive the field sensor data from the controller 302 and prepare the field sensor data for processing by the processing core 314. For example, the memory 312 may be a buffer. The processing core 314 may process the field sensor data to generate the SSCI parameters. The AI model 316 may be a neural network configured to process the field sensor data for generating or assisting in generating the SSCI parameters. Thus, the AI model 316 may provide AI enhancement to the processing core 314. The SSCI parameters may include at least one of a path loss, a K-factor, a delay spread, or a multi-path profile related to the radio environment.

The ray-tracing engine 304 may generate or refine a site-specific ray tracing model of the radio environment based on the field sensor data, and may generate the one or more SSCI parameters based on the site-specific ray tracing model. The site-specific ray tracing model may be a digital twin (e.g., a digital representation) of the radio environment. Thus, the ray-tracing engine 304 may generate a digital twin of the radio environment based on the field sensor data, and generate the one or more SSCI parameters based on the digital twin of the radio environment. In some implementations, the site-specific ray tracing model may be a heat map of the radio environment.

In some implementations, the ray-tracing engine 304 may analyze, using the AI model 316 (e.g., a machine learning model), the field sensor data to generate or refine the site-specific ray tracing model, and analyze, using the AI model 316, the site-specific ray tracing model to generate the one or more SSCI parameters.

Ray tracing may be a deterministic propagation model that utilizes details of an environment through which a ray travels to determine one or characteristics of the ray. For example, in some cases, the ray may comprise a wireless communication signal and the set of equations and algorithms of a ray tracing propagation model may be configured to estimate a path loss and phase change for the wireless communication signal while accounting for any reflection, refraction, scattering, and/or diffraction of the wireless communication signal that may be caused by objects within the environment via which the wireless communication signal is transmitted.

In some cases, ray tracing may comprise a geometric computation and an electromagnetic computation. The geometric computation may include determining a plurality of paths of a wireless communication signal from the transmitter to the receiver. In some cases, the geometric computation may determine the plurality of paths based on an individual ray (e.g., an individual wireless communication signal) that travels in a straight line through a homogenous medium, obeys the laws of reflection, refraction, and diffraction, and carries energy. In some cases, the geometric computation may further determine, for each of the plurality of paths, an angle of departure, an angle of arrival, and a propagation time (e.g., an amount of time for the wireless communication signal to travel from the transmitter to the receiver via the path).

In some cases, the paths may be predicted based on a snapshot. As used herein, a “snapshot” may refer to a set of data representing a depiction of an environment at a particular instant of time. In some cases, the depiction of the environment may include objects located within the environment. For example, at an instant of time, an environment may include a transmitter located at a first location, a building located at a second location, a vehicle located at a third location, and a receiver located at a fourth location. A snapshot of the environment at the first time may include a set of data indicating the transmitter located at the first location, the building located at the second location, the vehicle located at the third location, and the receiver located at the fourth location. A geometric computation based on the snapshot described above may include determining a plurality of paths that each have a starting point at a location of the transmitter (e.g., the first location) and an ending point at a location of the receiver (e.g., the fourth location).

In some cases, the depiction of the environment may include physical characteristics of the environment that may affect a propagation of the ray through the environment. For example, the environment may include a hill located between the transmitter and the receiver, a body of water that causes a deflection or diffraction of the ray, and/or a change in elevation that affects a line-of-sight (LOS) communication between the transmitter and the receiver, among other examples. In these cases, a snapshot of the environment may include a set of data representing the physical characteristics of the environment.

In some cases, the electromagnetic computation may include determining a tap response for each of the plurality of paths. In some cases, the tap response may include an estimated set of characteristics of the ray at the receiver. For example, the ray may correspond to a wireless communication signal and for each path, the electromagnetic computation may include estimating the characteristics of the wireless communication signal at a receiver based on the wireless communication signal traveling to the receiver via the path. In some cases, the tap response may include the mixing of wireless communication signals traveling different paths to simulate the effects of time in the mixing of multi-path signals.

The FBHT 306 may be an open network adapter (ONA). Thus, the FBHT 306 may facilitates communication, configuration, and management within a disaggregated and open RAN architecture. The FBHT 306 may serve as a bridge between different elements in the network to ensure interoperability and seamless operation. In some implementations, the FBHT 306 may be used to configure O-RAN components, such as the O-RU (e.g., RU 204), the O-DU, and the O-CU. During deployment, the FBHT 306 can act as a tool or intermediary to configure the O-RAN components. For example, the FBHT 306 may help to establish secure, standardized communication between the O-RU and the higher-layer units (O-DU and O-CU) via open interfaces (e.g., eCPRI or open fronthaul protocols). Additionally, the FBHT 306 may ensure that the O-RU receives proper network settings, timing synchronization, and operational parameters, such as the SSCI parameters.

The FBHT 306 may trigger the ray-tracing engine 304, via the controller 302, to perform ray tracing of the radio environment, where the ray tracing includes obtaining the field sensor data and generating the SSCI parameters based on the field sensor data. Additionally, the FBHT 306 may trigger the controller 302 to provide the SSCI parameters to the RU 204. For example, the FBHT 306 may send a trigger command to the controller 302 that causes the controller 302 to trigger the ray-tracing engine 304 to perform ray tracing of the radio environment. The trigger command may also cause the controller 302 to obtain the field sensor data relevant to the radio environment from the sensors 308, and provide the field sensor data to the ray-tracing engine 304. The trigger command may also include instructions that instruct the controller 302 to provide the SSCI parameters to the RU 204, once the SSCI parameters are received from the ray-tracing engine 304. In other words, the FBHT 306 may connect to the ray-tracing engine 304 via the controller 302 to trigger the ray-tracing engine 304 to generate the SSCI parameters that correspond to the radio environment associated with the coverage area of the RU 204 and to load the SSCI parameters into the RU 204.

In some implementations, FBHT 306 may connect to the RU 204 via the controller 302 to trigger the RU 204 to transmit test waveforms to be measured by one or more sensors 308 (or test UEs 310) deployed in the coverage area of the RU 204 for generating field sensor data (e.g., sensor-based data) that is provided to the ray-tracing engine 304 via the controller 302 to generate or refine the site-specific ray tracing model of the radio environment, from which the SSCI parameters are based.

The controller 302 may trigger the RU 204 to transmit the test waveforms to be measured by one or more sensors 308, for causing the one or more sensors 308 to generate the field sensor data based on measuring the test waveforms. The ray-tracing engine 304 may generate or refine a site-specific ray tracing model of the radio environment based on the field sensor data, and generate the one or more SSCI parameters based on the site-specific ray tracing model.

In some implementations, the controller 302 may receive updated field sensor data from the one or more sensors 308, provide the updated field sensor data to the ray-tracing engine 304, and trigger the ray-tracing engine 304 to generate one or more updated SSCI parameters. For example, after deployment, the controller 302 may periodically obtain updated field sensor data from the one or more sensors 308. In some case, the controller 302 may trigger the RU 204 to transmit test waveforms to be measured by one or more sensors 308, for causing the one or more sensors 308 to generate the updated field sensor data based on measuring the test waveforms. The ray-tracing engine 304 may generate or refine a site-specific ray tracing model of the radio environment based on the updated field sensor data, and generate the one or more updated SSCI parameters based on the site-specific ray tracing model, which may be updated relative to one or more previous site-specific ray tracing models. For example, the updated site-specific ray tracing model may be refined relative to the site-specific ray tracing model triggered by the FBHT 306. The controller 302 may provide the one or more updated SSCI parameters to the RU 204.

In some implementations, the RU 204 may generate channel state information (CSI) based on the one or more SSCI parameters. For example, the RU 204 may perform a channel estimation based on the one or more SSCI parameters to model one or more communication channels of the RU 204 and to generate CSI.

Additionally, or alternatively, the RU 204 may adapt one or more antenna parameters of the plurality of antennas based on the one or more SSCI parameters. For example, the one or more antenna parameters may include beamforming parameters, power allocation parameters, spatial multiplexing parameters, modulation scheme parameters, and/or error-correction coding parameters. In some implementations, the RU 204 is a massive MIMO O-RU, and the plurality of antennas includes massive MIMO antenna elements. Thus, the one or more antenna parameters may include one or more massive MIMO antenna parameters.

In some implementations, the RU 204 may analyze, using a machine learning model, the one or more SSCI parameters to adapt one or more antenna parameters of the plurality of antennas based on the one or more SSCI parameters.

In some examples, the RU 204 may include an adaption interface 318, a downlink (DL) beamforming unit 320, and an uplink (UL) neural receiver 322. The adaption interface 318 may include one or more processors configured to generate or otherwise adapt the CSI and/or antenna parameters based on the SSCI parameters or updated SSCI parameters received from the controller 302. In some examples, the adaption interface 318 may provide one or more SSCI parameters to the DL beamforming unit 320 and/or the UL neural receiver 322. The DL beamforming unit 320 may include one or more processors for performing DL beamforming. The UL neural receiver 322 may include one or more processors for performing channel estimation, UL beamforming, and channel equalization.

As indicated above, FIG. 3 is provided as an example. Other examples may differ from what is described with regard to FIG. 3. The number and arrangement of devices and components shown in FIG. 3 are provided as an example. In practice, there may be additional devices or components, fewer devices or components, different devices or components, or differently arranged devices or components than those shown in FIG. 3.

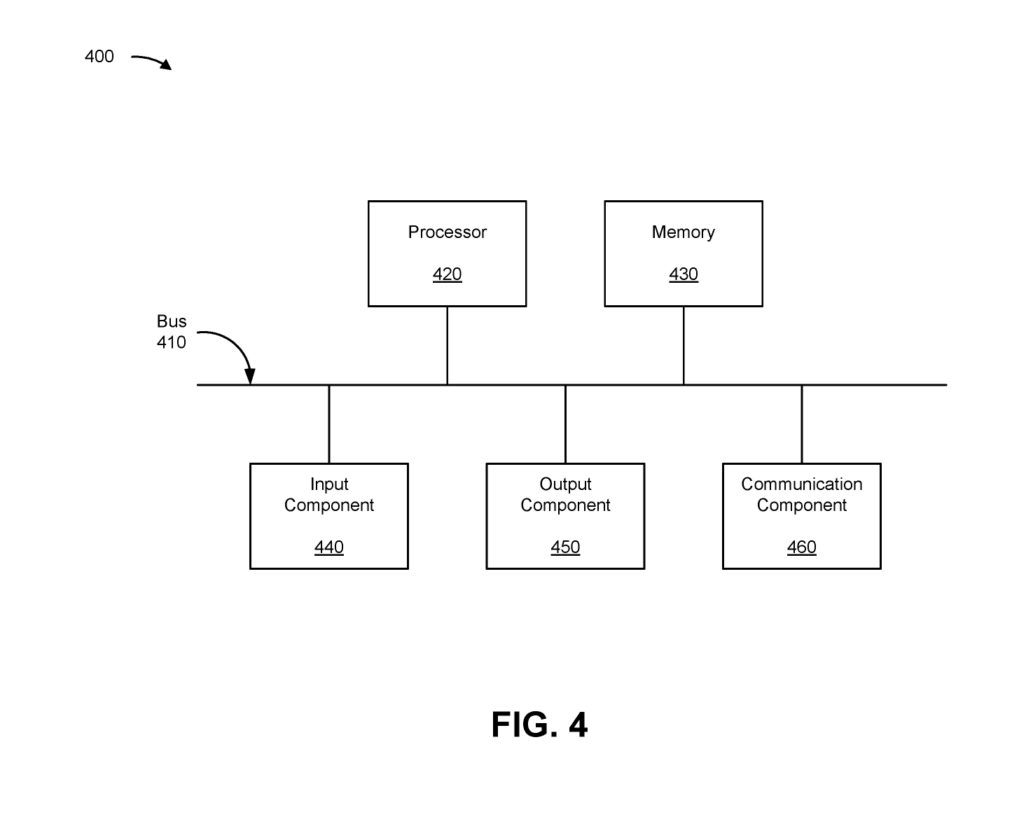

FIG. 4 is a diagram of example components of a device 400 associated with site-specific optimization of radio processing via digital twin simulation and field sensor-based data. The device 400 may correspond to RU 204, controller 302, ray-tracing engine 304, and/or FBHT 306. In some implementations, RU 204, controller 302, ray-tracing engine 304, and/or FBHT 306 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

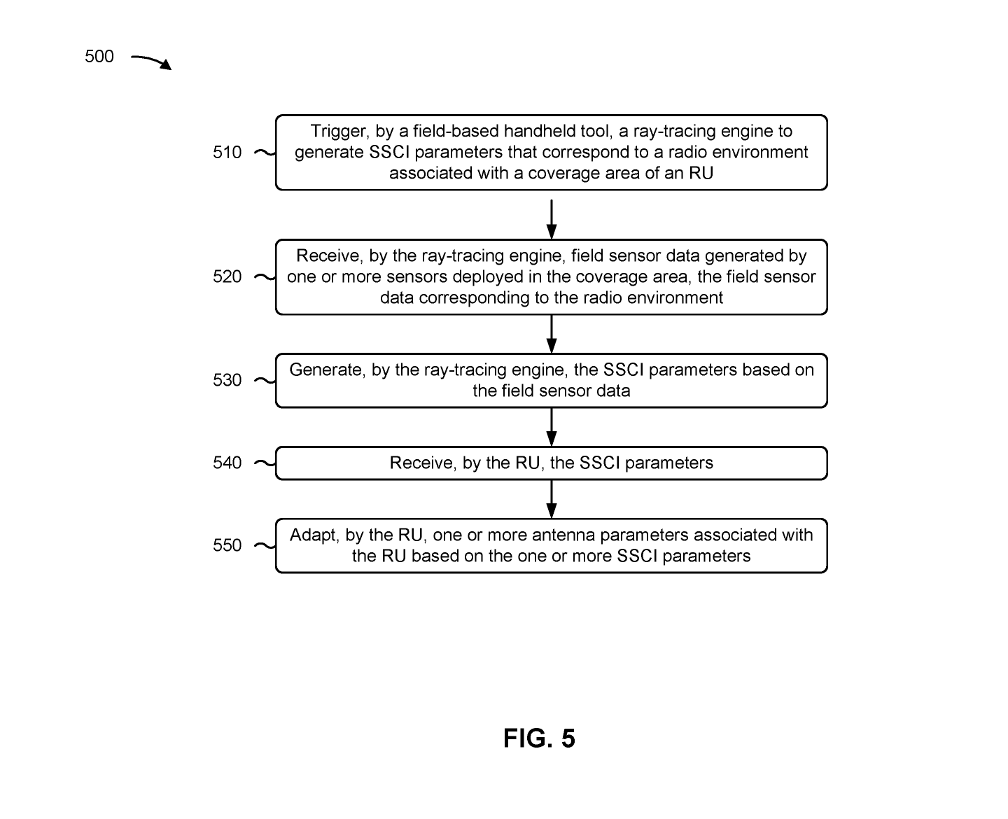

FIG. 5 is a flowchart of an example process 500 associated with site-specific optimization of radio processing via a digital twin simulation and field sensor-based data. In some implementations, one or more process blocks of FIG. 5 are performed by an RU (e.g., RU 204), a controller (e.g., controller 302), a ray-tracing engine (e.g., ray-tracing engine 304), and/or a field-based hand tool (e.g., FBHT 306). In some implementations, one or more process blocks of FIG. 5 are performed by another device or a group of devices separate from or including the system 300, such as a DU (e.g., DU 210), a CU (e.g., CU 212), and/or a core network (e.g., core network 208). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include triggering a ray-tracing engine to generate SSCI parameters that correspond to a radio environment associated with a coverage area of an RU (block 510). For example, the field-based hand tool may trigger the ray-tracing engine to generate SSCI parameters that correspond to the radio environment, as described above.

As further shown in FIG. 5, process 500 may include receiving field sensor data generated by one or more sensors deployed in the coverage area, the field sensor data corresponding to the radio environment (block 520). For example, the ray-tracing engine may receive the field sensor data generated, as described above.

As further shown in FIG. 5, process 500 may include generating the SSCI parameters based on the field sensor data (block 530). For example, the ray-tracing engine may generate the SSCI parameters based on the field sensor data, as described above.

As further shown in FIG. 5, process 500 may include receiving the SSCI parameters (block 540). For example, the RU may receive the SSCI parameters (e.g., from the ray-tracing engine), as described above.

As further shown in FIG. 5, process 500 may include adapting one or more antenna parameters associated with the RU based on the one or more SSCI parameters (block 550). For example, the RU may adapt one or more antenna parameters associated with the RU based on the one or more SSCI parameters, as described above.

Process 500 may include additional implementations, such as any single implementation or any combination of implementations described below and/or in connection with one or more other processes described elsewhere herein.

In a first implementation, process 500 includes triggering, by the FBHT, the RU to transmit test waveforms to be measured by one or more sensors deployed in the coverage area of the RU; and measuring, by the one or more sensors, the test waveforms to generate the field sensor data to be provided to the ray-tracing engine.

In a second implementation, process 500 includes triggering, by a controller, the RU to transmit test waveforms to be measured by one or more sensors deployed in the coverage area of the RU; and measuring, by the one or more sensors, the test waveforms to generate the field sensor data to be provided to the ray-tracing engine.

In a third implementation, process 500 includes generating, by the ray-tracing engine, a site-specific ray tracing model based on the field sensor data; generating, by the ray-tracing engine, the SSCI parameters based on site-specific ray tracing model; receiving, by the ray-tracing engine, updated field sensor data; generating, by the ray-tracing engine, an updated site-specific ray tracing model based on the updated field sensor data; generating, by the ray-tracing engine, updated SSCI parameters based on the updated site-specific ray tracing model; receiving, by the RU, the updated SSCI parameters; and adapting, by the RU, the one or more antenna parameters associated with the RU based on the one or more updated SSCI parameters.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for an open radio access network (RAN), comprising:
an open radio unit (O-RU) configured to transmit and receive radio frequency (RF) signals via a plurality of antennas according to one or more site-specific channel information (SSCI) parameters that correspond to a radio environment associated with a coverage area of the O-RU;
a ray-tracing engine configured to receive field sensor data generated by one or more sensors deployed in the coverage area, the field sensor data corresponding to the radio environment, and generate the one or more SSCI parameters based on the field sensor data; and
a controller communicatively coupled to the ray-tracing engine and the O-RU, wherein the controller is configured to receive the field sensor data and provide the field sensor data to the ray-tracing engine, and wherein the controller is further configured to receive the one or more SSCI parameters from the ray-tracing engine and provide the one or more SSCI parameters to the O-RU.

2. The system of claim 1, further comprising:
a field-based handheld tool (FBHT) communicatively coupled to the controller, wherein the FBHT is configured to:
trigger the ray-tracing engine, via the controller, to perform ray tracing of the radio environment, wherein the ray tracing includes obtaining the field sensor data and generating the one or more SSCI parameters based on the field sensor data, and
trigger the controller to provide the one or more SSCI parameters to the O-RU.

3. The system of claim 2, wherein the FBHT is configured to trigger the O-RU, via the controller, to transmit test waveforms to be measured by the one or more sensors, for causing the one or more sensors to generate the field sensor data based on measuring the test waveforms, and
wherein the ray-tracing engine is configured to generate or refine a site-specific ray tracing model of the radio environment based on the field sensor data, and generate the one or more SSCI parameters based on the site-specific ray tracing model.

4. The system of claim 3, wherein the ray-tracing engine is configured to:
analyze, using a machine learning model, the field sensor data to generate or refine the site-specific ray tracing model, and
analyze, using the machine learning model, the site-specific ray tracing model to generate the one or more SSCI parameters.

5. The system of claim 1, wherein the one or more SSCI parameters include at least one of a path loss, a K-factor, a delay spread, or a multi-path profile.

6. The system of claim 1, wherein the controller is configured to trigger the O-RU to transmit test waveforms to be measured by the one or more sensors, for causing the one or more sensors to generate the field sensor data based on measuring the test waveforms, and
wherein the ray-tracing engine is configured to generate or refine a site-specific ray tracing model of the radio environment based on the field sensor data, and generate the one or more SSCI parameters based on the site-specific ray tracing model.

7. The system of claim 1, wherein the controller is configured to receive updated field sensor data from the one or more sensors, provide the updated field sensor data to the ray-tracing engine, and trigger the ray-tracing engine to generate one or more updated SSCI parameters,
wherein the ray-tracing engine is configured to generate or refine a site-specific ray tracing model of the radio environment based on the updated field sensor data, and generate the one or more updated SSCI parameters based on the site-specific ray tracing model, and
wherein the controller is configured to provide the one or more updated SSCI parameters to the O-RU.

8. The system of claim 1, wherein the field sensor data include at least one of signal strength information, light detection and ranging (LIDAR) information, image information, or map information.

9. The system of claim 1, wherein the controller is a cloud-based controller configured to connect to the ray-tracing engine and the O-RU.

10. The system of claim 1, wherein the O-RU is configured to generate channel state information (CSI) based on the one or more SSCI parameters.

11. The system of claim 1, wherein the O-RU is configured to perform a channel estimation based on the one or more SSCI parameters to model one or more communication channels of the O-RU and to generate channel state information (CSI).

12. The system of claim 1, wherein the O-RU is configured to adapt one or more antenna parameters of the plurality of antennas based on the one or more SSCI parameters, and
wherein the one or more antenna parameters include at least one of beamforming parameters, power allocation parameters, spatial multiplexing parameters, modulation scheme parameters, or error-correction coding parameters.

13. The system of claim 1, wherein the O-RU is configured to analyze, using a machine learning model, the one or more SSCI parameters to adapt one or more antenna parameters of the plurality of antennas based on the one or more SSCI parameters.

14. The system of claim 1, wherein the O-RU is a massive multiple-input, multiple-output (MIMO) O-RU, and
wherein the plurality of antennas includes massive MIMO antenna elements.

15. A field-based handheld tool (FBHT) for a radio access network (RAN), the FBHT comprising:
a communication interface for being connected to a cloud-based controller of the RAN;
one or more memories; and
one or more processors, communicatively coupled to the one or more memories, configured to:
connect to a ray-tracing engine via the cloud-based controller to trigger the ray-tracing engine to generate site-specific channel information (SSCI) parameters that correspond to a radio environment associated with a coverage area of a radio unit (RU) and to load the SSCI parameters into the RU.

16. The FBHT of claim 15, wherein the one or more processors are configured to:
connect to the RU via the cloud-based controller to trigger the RU to transmit test waveforms to be measured by one or more sensors deployed in the coverage area of the RU for generating sensor-based data that is provided to the ray-tracing engine via the cloud-based controller to generate or refine a site-specific ray tracing model of the radio environment, from which the SSCI parameters are based.

17. A method of configuring a radio unit (RU) of a radio access network (RAN), the method comprising:
triggering, by a field-based handheld tool (FBHT), a ray-tracing engine to generate site-specific channel information (SSCI) parameters that correspond to a radio environment associated with a coverage area of a radio unit (RU);
receiving, by the ray-tracing engine, field sensor data generated by one or more sensors deployed in the coverage area, the field sensor data corresponding to the radio environment;
generating, by the ray-tracing engine, the SSCI parameters based on the field sensor data;
receiving, by the RU, the SSCI parameters; and
adapting, by the RU, one or more antenna parameters associated with the RU based on the one or more SSCI parameters.

18. The method of claim 17, further comprising:
triggering, by the FBHT, the RU to transmit test waveforms to be measured by one or more sensors deployed in the coverage area of the RU; and
measuring, by the one or more sensors, the test waveforms to generate the field sensor data to be provided to the ray-tracing engine.

19. The method of claim 17, further comprising:
triggering, by a controller, the RU to transmit test waveforms to be measured by one or more sensors deployed in the coverage area of the RU; and
measuring, by the one or more sensors, the test waveforms to generate the field sensor data to be provided to the ray-tracing engine.

20. The method of claim 17, further comprising:
generating, by the ray-tracing engine, a site-specific ray tracing model based on the field sensor data;
generating, by the ray-tracing engine, the SSCI parameters based on site-specific ray tracing model;
receiving, by the ray-tracing engine, updated field sensor data;
generating, by the ray-tracing engine, an updated site-specific ray tracing model based on the updated field sensor data;
generating, by the ray-tracing engine, updated SSCI parameters based on the updated site-specific ray tracing model;
receiving, by the RU, the updated SSCI parameters; and
adapting, by the RU, the one or more antenna parameters associated with the RU based on the one or more updated SSCI parameters.
